(19) United States
(12) Patent Application Publication
(10) Pub. No.: US 2003/0151152 A1
(43) Pub. Date: Aug. 14, 2003

(54) Body armor and methods for its production

(75) Inventors: Noah Nichelson, Wheat Ridge, CO (US); Gary Ross, Little Rock, AR (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: CoorsTek, Inc., Golden, CO (US)

(21) Appl. No.: 10/071,748

(22) Filed: Feb. 8, 2002

(51) Int. Cl. C04B 35/573

(52) U.S. Cl. 264/29.1; 264/669; 264/670; 501/88; 524/425; 106/287.13

(57) ABSTRACT

Exemplary silicon carbide ceramic bodies are produced according to the invention. An exemplary ceramic body includes silicon carbide in major amounts and an organic gelation agent in a minor amount. An exemplary ceramic body exhibits sufficient density and hardness to function as body armor.

### BACKGROUND OF THE INVENTION

The invention relates generally to the field of ceramic materials and processes for making ceramic materials. More specifically, the invention relates to reaction bonded silicon carbide body armor.

Effective body armor possesses several key qualities. First, body armor should have sufficient penetration resistance to prevent a projectile from penetrating the armor and reaching the wearer's body. Second, body armor should be as light as possible to minimize adverse effects on the wearer's mobility and comfort. Finally, body armor ideally should have sufficient compressive strength and rigidity to avoid deformation under the large forces produced by projectile impacts, so as to prevent blunt force trauma to that portion of the wearer's body behind the impacted region of the armor.

Several methods of producing body armor are known in the art. For example, vests comprising multiple layers of ballistic fabrics have long been used to protect a wearer from projectile threats. Another type of body armor involves the use of rigid panels made from hard materials such as steel, composites and the like. Unfortunately, however, the key qualities identified above often conflict with one another in various implementations of body armor. For instance, body armor composed of ballistic fabric made from materials such as DuPont Kevlar® or the like can be quite light and comfortable but may deform substantially, causing significant blunt force trauma to the wearer; moreover, such armor may not adequately protect against high velocity ballistic threats. On the other hand, body armor composed of steel panels exhibits high compressive strength and rigidity but may be so heavy and uncomfortable as to unduly hinder the wearer's movement or even discourage consistent use.

The National Institute of Justice has developed a classification system for body armor based upon the level of protection offered: Class I, Class IIA, Class II, and Class IIIA armor protect against various ballistic threats with velocities of up to 1430 ft/sec. Class III armor protects its wearer against a 7.62 mm, high-velocity, full metal jacketed rifle round at up to 2780 ft/sec. Class IV armor protects its wearer against a .3006 caliber, armor piercing round at 2850 ft/sec. Generally, Class III and IV protection cannot be obtained through the use of flexible armor made from ballistic cloth but instead require the use of some type of rigid panels.

Thus, it is beneficial to produce a piece of body armor that is both rigid and lightweight, with a high compressive strength. For instance, U.S. Pat. No. 5,306,557, the complete disclosure of which is incorporated herein by reference, teaches the combination of a boron carbide hard strike plate and additional layers of ballistic fabric to produce a piece of body armor that is rated at Class III or higher and is 40% to 60% lighter than previously available armor. Similarly, U.S. Pat. No. 3,977,294, the complete disclosure of which is incorporated herein, discusses the advantages of using ceramic materials instead of steel or other metals in body armor; that patent also recognizes, however, the difficulties and expense of producing ceramics with sufficient density to be effective as body armor. One reason for past difficulties and relatively high expenses in creating ceramic armor was the inability to produce a ceramic green body that had sufficient unfired strength to withstand a pressure-molding process, which allows for relatively simple and inexpensive production of relatively dense ceramic pieces.

Hence, it would be desirable to provide a ceramic piece of sufficient density to serve effectively as body armor. It would further be desirable to provide exemplary processes for making such pieces. Such processes should be relatively simple so that the production costs, and hence the overall end-user costs, may be minimized.

### BRIEF SUMMARY OF THE INVENTION

The invention provides exemplary silicon carbide ceramic bodies and processes for making such ceramic bodies. The silicon carbide ceramic bodies of the invention comprise silicon carbide in a major amount and an organic gelation agent in a minor amount. The organic gelation agent provides green body strength.

In one particular aspect, the ceramic body comprises from about 0.01 wt % to about 5 wt % of the gelation agent. In another aspect, the ceramic body comprises about 0.1 wt % of potato starch as the gelation agent. One benefit of the present invention is the surprising and unexpected efficacy of using relatively small amounts of gelation agents to achieve relatively substantial increases in green body strength, as described below. In yet another aspect, the ceramic body comprises at least about 60 wt % of silicon carbide.

The ceramic body may be fashioned into a variety of parts or components using a pressure cast molding technique described in detail below. For example, the ceramic body may comprise body armor, structural members, electronic components, radiant heat products or the like.

The invention further provides an exemplary process for producing a reaction bonded silicon carbide body. According to the process, an organic gelation agent is incorporated with a carbon source and a silicon carbide source to form a ceramic slurry. The slurry is then siliconized to produce a reaction bonded silicon carbide body. Siliconization can be any process by which the ceramic is exposed to molten silicon, as described below. The carbon source for the reaction bonding process may comprise any one of a variety of carbon sources including graphite, carbon black, pyrolized resins, and the like.

Prior to siliconization, the ceramic slurry is compacted into a green body, which in turn is siliconized to produce the reaction bonded silicon carbide body. In certain embodiments, compaction is accomplished through pressure cast molding. In the past, such pressure casting was infeasible because the green bodies would break when removed from the mold. Additionally, slurry material would segregate under pressure, producing a non-homogenous cast body. In the present embodiments, however, the organic gelation agent provides sufficient green strength to withstand this form of compaction, which provides a relatively simple and inexpensive process for producing ceramic bodies of relatively high density.

In some embodiments, the ceramic slurry includes a silicon carbide in a major amount, a carbon source in a moderate amount, an organic gelation agent in a minor amount, and a liquid in a moderate amount. For purposes of this document, a major amount is defined as more than 35 wt % of the overall combination, a moderate amount is defined as not less than 10 wt % and not more than 35% of the overall combination and a minor amount is defined as not more than 20 wt % of the overall combination. In one embodiment, the ceramic slurry includes about 10 weight percent to about 35 weight percent carbon source, about 90 weight percent to about 40 weight percent silicon carbide powder and about 0 weight percent to about 15 weight percent gelation agent. In one particular aspect, after compaction into the green body, the green body is heated to a temperature in the range from about 1400° C. to about 1650° C. to facilitate exposure of the liquid silicon metal to the green body.

By using a ceramic slurry having about 10 wt % to about 35 wt % carbon source, and about 90 weight percent to about 40 (and more preferably about 65) weight percent silicon carbide powder, a more complete conversion of the carbon into silicon carbide is achieved. Because of the lack of residual graphite, a material is produced having a relatively high density and which is relatively hard. For example, a silicon carbide body may be produced having an average density of at least about 3.00 g/cc, more preferably at least about 3.04 g/cc. The high density also contributes to the stiffness, hardness, compressive and flexural strength, abrasion resistance, and other physical characteristics that allow the material to be used as body armor.

In another embodiment, the invention provides an exemplary ceramic slurry for producing a reaction bonded ceramic body. The slurry comprises a silicon carbide powder in major amount, a carbon source in moderate amount and a liquid in a moderate amount. An organic gelation agent in minor amount is also provided. In one aspect, the organic gelation agent comprises from about 0.01 wt % to about 5 wt % potato starch.

In yet another embodiment, the invention provides an exemplary green body for producing a reaction bonded ceramic body. The green body comprises a silicon carbide powder in major amount, a carbon source in moderate amount, a liquid in a moderate amount and an organic gelation agent in a minor amount. In one aspect, the organic gelation agent comprises from about 0.01 wt % to about 5 wt % potato starch.

### BRIEF DESCRIPTION OF THE DRAWINGS

FIG. 1 is a flowchart illustrating an exemplary process for producing a reaction bonded silicon carbide body according to the invention.

FIG. 2 illustrates an exemplary armor torso that is constructed of a silicon carbide body according to the invention.

### DESCRIPTION OF THE SPECIFIC EMBODIMENTS

The invention provides exemplary silicon carbide ceramic bodies and methods for producing such silicon carbide ceramic bodies. In a broad sense, the ceramic bodies of the invention comprise a silicon carbide material and an organic gelation agent. The organic gelation agent may include any one of a variety of materials which impart additional green strength to the ceramic bodies such that the green bodies will not break during a pressure casting process. Exemplary gelation agents that may be employed by the invention include: various starches, such as potato, corn, tapioca, wheat and the like; methyl-cellulose and its substituted derivatives; carboxy-methyl-cellulose gum; guar gum; sodium alginate, gum arabic; lignosulfates; polyacrylates; polyvinyl-butyrals and acrylics. Each of the gelation agents has specific advantages: for example, potato starch is relatively inexpensive, non-toxic and abundant; it also imparts relatively high green strength to the bodies.

Merely by way of example, silicon carbide ceramic bodies produced according to the invention are useful in a wide variety of applications. Because the green bodies are resistant to breakage during pressure casting, the ceramic bodies can be cast in essentially any desired shape or configuration. That fact, combined with the relatively high stiffness, hardness, abrasion resistance and flexural strength of the ceramic bodies, along with their relatively low density for such hard materials, makes the ceramic bodies useful as body armor, protective shielding, strike plates, electronic components, structural members, radiant heat products, and the like.

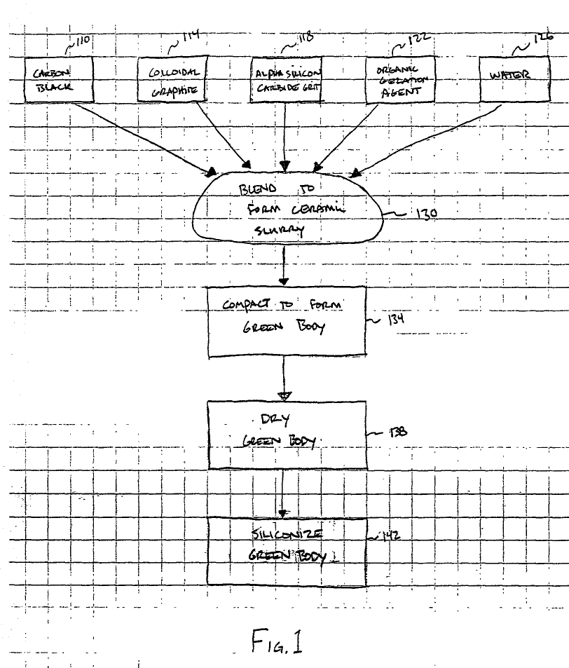

Referring now to FIG. 1, an exemplary method for producing a reaction bonded silicon carbide ceramic body will be described. The process begins by producing a ceramic slurry by combining carbon black 110, colloidal graphite 114, alpha silicon carbide grit 118, and an organic gelation agent 122 with water 126 to form a ceramic slurry 130. Of course, one skilled in the art will recognize that in addition to carbon black 110 and colloidal graphite 114, other carbon sources may be used as well, including for example, pyrolized resins, furfural alcohol-glycol mixtures, and the like. Similarly, while this exemplary process uses alpha silicon carbide grit 118, typically having a size in the range from about 240 grit to about 1200 grit, and more preferably about 600 grit, it will be appreciated that other grit classes, as well as other forms of silicon carbide, may also be used. Likewise, while the illustrated embodiment uses water, those skilled in the art will understand that a variety of other liquids, for example oils or alcohols, could be used as solvents as well.

The carbon black 110, colloidal graphite 114, alpha silicon carbide grit 118, organic gelation agent 122 and water 126 may be mixed or blended using equipment generally known in the art. In one embodiment, a high shear, high intensity mixer is used. In certain embodiments, the resulting ceramic slurry mixture includes from about 0 weight percent to about 20 weight percent, and more preferably from about 10 weight percent to about 20 weight percent, carbon black, from about 0 weight percent to about 15 weight percent, and more preferably from about 3 weight percent to about 10 weight percent, colloidal graphite, from about 90 weight percent to about 40 weight percent, and more preferably from about 90 weight percent to about 60 weight percent, alpha silicon carbide grit, and from about 0.01 weight percent to about 15 weight percent, and more preferably from about 0.1 weight percent to about 5 weight percent, organic gelation agent. In one embodiment, the organic gelation agent comprises potato starch and is about 0.1 weight percent of the ceramic slurry.

The use of silicon carbide powder in the range from about 90 weight percent to about 60 weight percent tends to produce silicon carbide parts having a relatively high density and hardness. For example, the density may be greater than about 3.00 g/cc, and the hardness of the matrix may be greater than about 24.5 GPa. In this way, such parts may be used in applications requiring high abrasion resistance and low deformability and penetrability.

As illustrated in block 134, the ceramic slurry is formed and compacted into a green body. In one embodiment, the green body is forced into a synthetic or plaster mold using a commercially available pressure cast apparatus and is subjected to pressure from about 70 psig to about 600 psig, and more preferably from about 220 psig to about 580 psig, for about 10 seconds to about 240 seconds, and more preferably for about 60 seconds to about 120 seconds. In accordance with this embodiment, the mold should be porous, having a pore size from about 2 microns to about 20 microns, more preferably from about 6 microns to about 10 microns. Pressure casting the green bodies using a porous mold forces water out of the green body, reducing its moisture content and imparting additional structural integrity. Those skilled in the art will recognize, however, that other compaction techniques, for instance, slip casting, could be used as well. Following green forming, the green body may be shaped as specified by the end user, as is known in the art. In some embodiments, prior to green forming, the ceramic slurry is agitated at low shear in a commercially available mixer under vacuum conditions for about 4 hours to about 15 hours, and more preferably for about 6 to about 10 hours.

In certain embodiments, the green body may be placed in a drying apparatus, such as a commercially available conveyor drying oven, for a period of about 5 minutes to about 12 minutes, at a temperature of about 30° C. to about 200° C., and more preferably about 90° C. to about 150° C., as illustrated in block 138. In other embodiments, the green body comprises about 5 wt % to about 17 wt % carbon black, about 3 wt % to about 11 wt % colloidal graphite, about 60 wt % to about 86 wt % alpha silicon carbide grit, about 0.01 wt % to about 17 wt % organic gelation agent and about 5 wt % to about 15 wt % liquid.

The green body is then siliconized by exposing the green body to liquid or molten silicon as illustrated in block 142. Siliconization may be accomplished by a variety of techniques, including wicking, direct contact, capillary infiltration, vapor exposure, and the like. In one aspect, exposure to the liquid silicon will occur within a furnace having a temperature in the range from about 1400° C. to about 1650° C. under vacuum conditions. The green body remains within the furnace for a time sufficient to allow the silicon metal to infiltrate the entire green body. In one particular aspect, the green body is fired for about 1 hour to about 4 hours. After being exposed to the liquid silicon metal, the reaction bonding process is complete and a reaction bonded silicon carbide ceramic body is produced. In some embodiments, excess silicon metal is removed by sandblasting after the firing process has finished.

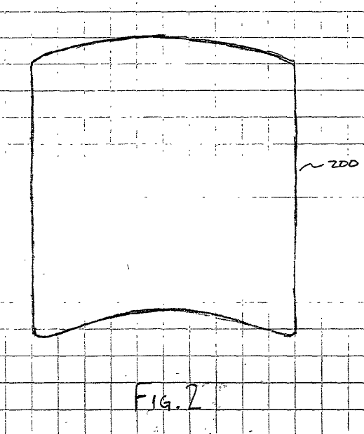

Shown in FIG. 2 is an armor torso 200 that may be produced according to the processes described herein. In addition to producing armor torsos, the processes of the invention may be employed to produce many other useful products as well. For instance, the low penetrability of the ceramic bodies makes them useful as strike plates, ballistic shields and other protective parts. In another aspect, the high compressive strength of the bodies allows them to be cast as structural members and in other load-bearing applications. Additionally, the bodies' relatively high heat tolerance and electrical and thermal conductivity allow them to be used as electrical components, in radiant heat applications, and the like. Finally, the high abrasion resistance of the bodies renders them useful as brake pads and in other frictional applications.

### EXAMPLE

A reaction bonded silicon carbide ceramic body was produced according to the following process. A ceramic slurry was formed by combining a dry mixture with water. The dry mixture comprised colloidal graphite, carbon black, silicon carbide powder and water. The colloidal graphite was 3.6 dry weight percent, the carbon black was 10.4 dry weight percent and the silicon carbide powder was 85.9 dry weight percent. The dry mixture also comprised 0.1 dry weight percent potato starch as a gelation agent. The dry mixture was combined with water in a ratio of 23.1 wt % water and 76.9 wt % dry mixture to form a ceramic slurry. The colloidal graphite and carbon black were commonly available commercial products familiar to those skilled in the art. The silicon carbide powder was a commonly commercially available 240 and 1200 grit silicon carbide powder, sold under the brand name of ESK, Kempten, Germany. The potato starch was a commercially available product sold under the brand name of Redisol 78-D by Staley Manufacturing Company, Decatur, Ill. The ceramic slurry was mixed for 15 minutes in commonly commercially available high intensity, high shear mixer and then was constantly agitated at low shear for 10 hours under vacuum conditions.

The slurry was placed in porous resin mold with a pore size of 8 microns, commercially available from Elmeceram, Oradour Sur Vayers, France. The slurry was then subjected to 220 psi for 130 seconds in a pressure cast apparatus, also available from Elmeceram, to produce a green body with approximately 10 weight percent moisture and substantial rigidity. The green body was removed from the mold with a short water burst. Surprisingly, the use of a relatively small amount of gelation agent in the ceramic slurry imparted higher than expected green strength to the formed body, such that the body maintained structural integrity throughout the molding and removal process, and prevented the slurry from segregating during the casting process, providing a green body of homogenous composition.

After removal from the mold, the green body was placed on a drying setter to maintain shape and placed into a conveyor drying oven at 100° C. for 12 minutes. After drying, the piece was substantially dry and could be stored indefinitely. The green body was then placed in a commonly commercially available, induction heated graphite furnace. The green body was placed in the furnace when cold and then ramped up to a temperature of greater than 1412° C. under vacuum conditions for 3 hours. While in the furnace, the green body was exposed to liquid silicon metal using a capillary infiltration technique. The liquid silicon metal reacted with any free carbon or graphite in the piece, forming amorphous silicon carbide. Remaining residual porosity was filled with free silicon metal.

After firing, the ceramic body was allowed to cool to room temperature. Excess silicon metal was removed from the piece by sand blasting. The resulting body had a density of about 3.05 g/cc, and a hardness of the matrix of about 24.5 GPa.

The invention has now been described in detail. However, it will be appreciated that the invention may be carried out in ways other than those illustrated in the aforesaid specific Examples. Accordingly, the scope of this invention is not to be limited by those specific Examples, but rather is to be accorded the full scope represented in the following claims.

What is claimed is:

1. A process for producing a reaction bonded silicon carbide body, the process comprising:
combining a carbon source, silicon carbide, an organic gelation agent and a liquid to form a ceramic slurry;
compacting the ceramic slurry into a green body; and
exposing the green body to liquid silicon metal to produce a reaction bonded silicon carbide body.

2. A process as in claim 1, wherein the carbon source is selected from the group consisting of carbon black and colloidal graphite, and the silicon carbide comprises alpha silicon carbide grit.

3. A process as in claim 1, wherein the ceramic slurry includes about 0 wt % to about 20 wt % carbon black, about 0 wt % to about 15 wt % colloidal graphite, about 40 wt % to about 90 wt % alpha silicon carbide grit, about 0.01 wt % to about 15 wt % organic gelation agent and about 10 wt % to about 30 wt % liquid.

4. A process as in claim 1, wherein the organic gelation agent is selected from a group consisting of corn starch, potato starch, tapioca starch, wheat starch, methyl-cellulose, substituted derivatives of methyl-cellulose, carboxy-methyl-cellulose gum, guar gum, sodium alginate, gum arabic, lignosulfonates, polyacrylates, polyvinyl-butyrals and acrylics.

5. A process as in claim 1, wherein the ceramic slurry includes about 0.01 wt % to about 5 wt % potato starch as a gelation agent.

6. A process as in claim 1, further comprising heating the green body to a temperature of about 1400° C. to about 1650° C. during siliconization.

7. A process as in claim 1, wherein siliconization comprises exposing the green body to about 20 wt % to 150 wt % (based on green body weight) liquid silicon metal.

8. A process as in claim 1, wherein compacting the ceramic slurry comprises forcing the ceramic slurry into a porous mold with a pore size of about 2 microns to about 20 microns and applying pressure of about 70 psig to about 600 psig for about 10 seconds to about 240 seconds.

9. A process as in claim 1, further comprising agitating the ceramic slurry continuously at low shear for about 4 hours to about 15 hours under vacuum conditions.

10. A process as in claim 1, wherein combining further comprises mixing the ceramic slurry for about 10 minutes to about 60 minutes using a high shear, high intensity mixer.

11. A process as in claim 1, further comprising drying the green body in a conveyor drying oven at about 30° C. to about 200° C. for about 5 minutes to about 12 minutes.

12. A process as in claim 1, wherein the silicon carbide body comprises an armor torso.

13. A reaction bonded silicon carbide body produced according to the process of claim 1.

14. A body as in claim 13, wherein the silicon carbide body comprises an armor torso.

15. A green body, comprising:
silicon carbide in a major amount;
a carbon source in a moderate amount;
an organic gelation agent in a minor amount;
and a liquid in a moderate amount.

16. A body as in claim 15, wherein the carbon source is selected from the group consisting of carbon black and colloidal graphite, and the silicon carbide comprises alpha silicon carbide grit.

17. A body as in claim 15, wherein the green body comprises about 5 wt % to about 17 wt % carbon black, about 3 wt % to about 11 wt % colloidal graphite, about 60 wt % to about 86 wt % alpha silicon carbide grit, about 0.01 wt % to about 17 wt % organic gelation agent and about 5 wt % to about 15 wt % liquid.

18. A body as in claim 15, wherein the organic gelation agent is selected from a group consisting of corn starch, potato starch, tapioca starch, wheat starch, methyl-cellulose, substituted derivatives of methyl-cellulose, carboxy-methyl-cellulose gum, guar gum, sodium alginate, gum arabic, lignosulfonates, polyacrylates, polyvinyl-butyrals and acrylics.

19. A body as in claim 18, wherein the green body comprises about 0.01 wt % to about 5 wt % potato starch as the organic gelation agent.

20. A ceramic slurry for producing a reaction bonded ceramic body, the ceramic slurry comprising:
silicon carbide in a major amount;
a carbon source in a moderate amount;
an organic gelation agent in a minor amount; and
a liquid in a moderate amount.

21. A ceramic slurry as in claim 20, wherein the carbon source is selected from the group consisting of carbon black and colloidal graphite, and the silicon carbide comprises alpha silicon carbide grit

22. A ceramic slurry as in claim 20, wherein the slurry includes about 0 wt % to about 20 wt % carbon black, about 0 wt % to about 15 wt % colloidal graphite, about 40 wt % to about 90 wt % alpha silicon carbide grit, about 0.01 wt % to about 15 wt % organic gelation agent and about 10 wt % to about 30 wt % liquid.

23. A ceramic slurry as in claim 20, wherein the organic gelation agent is selected from the group consisting of corn starch, potato starch, tapioca starch, wheat starch, methyl-cellulose, substituted derivatives of methyl-cellulose, carboxy-methyl-cellulose gum, guar gum, sodium alginate, gum arabic, lignosulfonates, polyacrylates, polyvinyl-butyrals and acrylics.

24. A ceramic slurry as in claim 23, wherein the ceramic slurry comprises about 0.01 wt % to about 5 wt % potato starch as the organic gelation agent.
